(19) United States
(12) Patent Application Publication
(10) Pub. No.: US 2007/0064351 A1
(43) Pub. Date: Mar. 22, 2007

(54) Spin filter junction and method of fabricating the same

(76) Inventors: Shan X. Wang, Portola Valley, CA (US); George Michael Chapline, Alamo, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/520,489

(22) Filed: Sep. 12, 2006

Related U.S. Application Data
(60) Provisional application No. 60/717,043, filed on Sep. 13, 2005.

(51) Int. Cl. G11B 5/33

(52) U.S. Cl. 360/324.2

(57) ABSTRACT

A magnetic tunnel-junction having a first electrode separated from a second electrode by a tunneling barrier is provided. The tunneling barrier is a ferromagnetic insulator that provides a spin dependent barrier energy for tunneling. The first electrode includes a ferromagnetic, electrically conductive layer. Electrons emitted from the first electrode toward the tunneling barrier are partially or completely spin-polarized according to the magnetization of the ferromagnetic electrode layer. The electrical resistance of the tunnel junction depends on the relative orientation of the electrode layer magnetization and the tunneling barrier magnetization. Such tunnel junctions are widely applicable to spintronic devices, such as spin valves, magnetic tunnel junctions, spin switches, spin valve transistors, spin filters, and to spintronic applications such as magnetic recording, magnetic random access memory, ultrasensitive magnetic field sensing (including magnetic biosensing), spin injection and spin detection.

### CROSS REFERENCE TO RELATED APPLICATIONS

This application claims the benefit of U.S. provisional application 60/717,043, filed on Sep. 13, 2005, entitled “Spin Filter Junction and Method of Fabricating the Same”, and hereby incorporated by reference in its entirety.

### GOVERNMENT SPONSORSHIP

This invention was made with Government support under grant number ECS-0103302 from the National Science Foundation. The Government has certain rights in this invention.

### FIELD OF THE INVENTION

This invention relates to magnetic spin filtering, and to associated spintronic devices.

### BACKGROUND

Spintronics is a field of electronics based on manipulating electron spin within devices. Spintronics is of interest because of the relatively small amount of energy required to manipulate spins, as well as the possibilities inherent in exploiting the quantum nature of single spins. Methods for generating and detecting spin-polarized electrons are basic building blocks for spintronic devices, and various proposals have been considered in the art.

For example, spin filtering by electron tunneling through a ferromagnetic insulating tunnel barrier has been experimentally demonstrated in an EuS barrier. Such a barrier provides different barrier-energies for spin up and spin down electrons, an effect referred to as exchange splitting. Since the tunneling probability through a barrier depends sensitively on barrier energy, such an arrangement can act as a spin filter by preferentially passing electrons having the energetically favored spin. However, the Curie temperature of EuS is only 16.8 K. At temperatures above the Curie temperature, EuS is not ferromagnetic, so an EuS tunneling barrier does not provide exchange splitting and therefore does not act as a spin filter. Thus this early work on spin filtering does not readily lead to room temperature spintronic devices.

In U.S. 2002/0064004 by Worledge, a double spin filter tunnel junction is considered. In this work, the tunneling barrier has two layers with independently controllable magnetization. Such an arrangement can be regarded as two spin filters in series. Although this structure is expected to provide sensitive magnetoresistive sensors and related devices, there are practical challenges in realizing such a device. In particular, the requirement that the two layers of the tunneling barrier have independently controllable magnetization presents difficulties. The known remedy of placing a non-magnetic decoupling layer between the two layers of the tunneling barrier to decouple them undesirably increases the tunneling barrier thickness, which can decrease device performance.

In the preceding examples, the relevant physical effect is quantum-mechanical electron tunneling through a barrier having a different barrier energy for spin up electrons than for spin down electrons. Tunneling from one ferromagnetic electrode to another ferromagnetic electrode through a non-magnetic insulating tunneling barrier has also been considered, and the resulting effect is often referred to as tunnel magnetoresistance (TMR). Although the barrier energy does not depend on spin in a TMR device, the density of final states available for tunneling does depend on the relative orientation of the magnetizations of the two ferromagnetic electrodes, thereby providing a magnetization-dependent resistance. U.S. Pat. No. 5,629,922 considers a TMR-based magnetoresistive sensor. U.S. Pat. No. 6,781,801 considers a TMR device where a spin filter is employed to spin-polarize the TMR device sense current, thereby increasing the magnetoresistance (MR) ratio. However, it is expected that devices based on a spin-dependent tunneling barrier energy should outperform TMR devices, since the tunneling current depends more sensitively on barrier energy than on the density of final states.

Accordingly, it would be an advance in the art to provide tunneling spin filter junctions suitable for operation at room temperature and providing high performance.

### SUMMARY

A magnetic tunnel junction having a first electrode separated from a second electrode by a tunneling barrier is provided. The tunneling barrier is a ferromagnetic insulator that provides a spin dependent barrier energy for tunneling. The first electrode includes a ferromagnetic, electrically conductive layer. Electrons emitted from the first electrode toward the tunneling barrier are partially or completely spin-polarized according to the magnetization of the ferromagnetic electrode layer. The electrical resistance of the tunnel junction depends on the relative orientation of the electrode layer magnetization and the tunneling barrier magnetization. Such tunnel junctions are widely applicable to spintronic devices, such as spin valves, magnetic tunnel junctions, spin switches, spin valve transistors, spin filters, and to spintronic applications such as magnetic recording, magnetic random access memory, ultrasensitive magnetic field sensing (including magnetic biosensing), spin injection and spin detection.

### BRIEF DESCRIPTION OF THE DRAWINGS

FIGS. 1a-c show a first embodiment of the invention in various operating states.

FIG. 2 shows a second embodiment of the invention.

FIG. 3 shows a third embodiment of the invention.

FIG. 4 shows a two terminal semiconductor device according to an embodiment of the invention.

FIG. 5 shows a three terminal semiconductor device according to an embodiment of the invention.

FIG. 6 shows measured I-V curves from an embodiment of the invention.

FIG. 7 shows measured magnetoresistance ratios from an embodiment of the invention.

FIGS. 8a-b show calculated magnetoresistance ratios for various embodiments of the invention.

### DETAILED DESCRIPTION

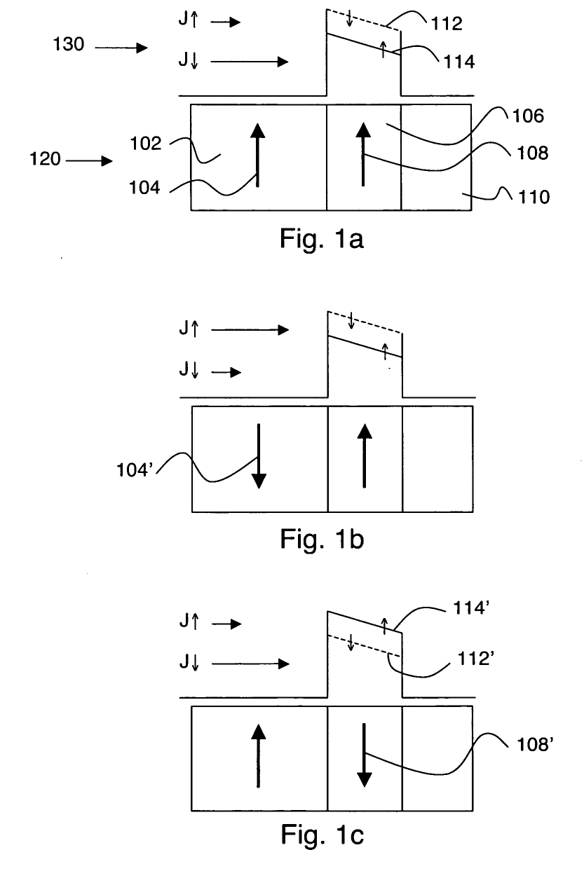

FIGS. 1a-c show a first embodiment of the invention in various operating states. On FIG. 1a, a tunnel junction 120 includes a first electrode 102 having a first magnetization direction 104 separated from a second electrode 110 by a tunneling barrier 106 having a second magnetization direction 108. In this example, first electrode 102 is an electrically conductive ferromagnetic layer, tunneling barrier 106 is a ferromagnetic electrically insulating layer, and second electrode 110 is electrically conductive and non-magnetic. Second electrode 110 can include any electrically conductive material (e.g., Au). In some embodiments of the invention, second electrode 110 is non-magnetic. Magnetoresistance is observed regardless the direction of current or spin flow. In preferred embodiments of the invention, second electrode 110 is magnetic or spin-polarized. In these embodiments, spin polarization of second electrode 110 can further enhance the spin-dependent tunneling process described below. Such enhancement is analogous to the behavior of conventional magnetic tunnel junctions. In cases where second electrode 110 is magnetic, its magnetization can be coupled to the magnetization of barrier 106 or it can be independent of the magnetization of barrier 106.

An electron energy band diagram 130 shows features of importance for device operation. In particular, exchange splitting in tunneling barrier 106 provides tunneling barriers having different barrier energies for spin up electrons (barrier 114) than for spin down electrons (barrier 112). In this example, when magnetization direction 108 is “up”, the spin down energy barrier (barrier 112) is higher than the spin up energy barrier (barrier 114). It is also possible for this relation between magnetization 108 and the relative heights of the spin up and spin down energy barrier to be reversed, depending on properties of the material selected for tunneling barrier 106. Device operation does not critically depend on whether the spin up barrier or the spin down barrier is higher for “up” magnetization.

Electrons emitted from first electrode 102 toward tunneling barrier 106 are substantially spin polarized according to magnetization direction 104. The example of FIGS. 1a-c shows negative spin polarization, where the spin-down current density J↓ is greater than the spin-up current density J↑ for “up” magnetization 104. Thus negative spin polarization relates to situations where electron spin tends to be anti-parallel to the magnetization. Positive spin-polarization, where electron spin tends to be parallel to magnetization direction 104, is also possible, depending on the composition and/or structure of first electrode 102. Device operation does not depend critically on whether the spin polarization provided by first electrode 102 is positive or negative. The degree of spin polarization can be defined as the ratio of the difference of spin up electrons and spin down electrons over their sum. Usually, only electrons at the Fermi level are relevant for the calculation of spin polarization, since tunneling primarily involves electrons at or near the Fermi level. Preferably, this ratio is greater than 25%, and more preferably this ratio is closer to 100% (e.g., >85%).

A key aspect of the invention is that the combination of a spin-polarized first electrode with a spin-dependent tunneling barrier provides magnetoresistance in a relatively simple device configuration. A single spin-dependent tunneling barrier by itself does not provide magnetoresistance. Although a double spin-dependent tunneling barrier can provide magnetoresistance, significant complications arise in practice, as described above. In the example of FIGS. 1a-c, the electrical resistance of tunnel junction 120 between the first and second electrodes depends on the relative orientation of first and second magnetization directions 104 and 108.

FIG. 1a shows a relatively high-resistance state, since most of the current provided by electrode 102 is spin-down, and the spin-down tunneling barrier 112 is higher than the spin-up tunneling barrier 114. If the magnetization of first electrode 102 is switched to “down” as shown by 104′ on FIG. 1b, the relative proportion of spin-up and spin-down current provided to tunneling barrier 106 is switched. In this case, most of the current provided to tunneling barrier 106 is spin-up, which has the lower energy barrier. Thus FIG. 1b shows a relatively low resistance state. If the magnetization of tunneling barrier 106 is switched to “down”, as shown by 108′ on FIG. 1c, the barrier heights for spin-up and spin-down electrons are switched compared to FIG. 1a. Thus barrier 114′ for spin-up electrons is higher than barrier 112′ for spin-down electrons on FIG. 1c. Since most of the current on FIG. 1c is spin-down, which has the lower energy tunneling barrier, FIG. 1c also shows a relatively low resistance state.

Since tunneling barrier 106 must provide a tunneling barrier to electrons, it can be an electrical insulator (or semiconductor) that acts as an electrical insulator in tunnel junction 120. Tunneling barrier 106 is also ferromagnetic, and preferably its Curie temperature is well above room temperature, so that device operation at or near room-temperature will not be impaired by approaching too closely to, or crossing, the ferromagnetic-nonmagnetic phase transition. Suitable tunneling barrier materials include, but are not limited to, ferrites such as CoFe₂O₄, NiFe₂O₄, and MnFe₂O₄, and ferromagnetic semiconductors such as Co-doped TiO₂, Mn-doped GaN, Al and Cr doped GaN, etc. (see S. A. Wolf et al., IBM Journal of Research & Development, vol. 50(1), p. 101.).

In this example, first electrode 102 is an electrically conductive ferromagnet having substantial spin polarization. The Curie temperature of first electrode 102 is also preferably well above room temperature. Half-metallic ferromagnets should provide ˜100% spin polarization, and are therefore attractive candidate materials for first electrode 102. Although these materials tend to be difficult to grow in thin film form at this time, they may become more readily available in the future. Other suitable materials for first electrode 102 that can provide substantial spin polarization include, but are not limited to Fe₃O₄, La_{2/3}Sr_{1/3}MnO₃, CrO₂, Co doped ZnO, and any ferromagnetic alloy containing Co, Fe, and/or Ni. First electrode 102 can also be a multilayer structure designed to provide spin-polarized current to tunnel barrier 106, as described below in connection with FIG. 3.

Since the resistance of tunnel junction 120 depends on the relative orientation of magnetization directions 104 and 108, sensing an external magnetic field relies on keeping one of magnetization directions 104 and 108 fixed and independent of the external field, while the other of magnetization directions 104 and 108 is free to follow the external field. A layer having a fixed magnetization direction is customarily referred to as a pinned layer, while a layer having a magnetization that can follow an external magnetic field is customarily referred to as a free layer. Thus one of layers 102 and 106 should be pinned and the other should be free, in order to provide a MR sensor. Electrode 102 can be free and barrier 106 can be pinned (FIG. 1b), or electrode 102 can be pinned and barrier 106 can be free (FIG. 1c). Device operation does not depend critically on which layer is pinned and which layer is free.

In some cases, the coercivity of the pinned layer is sufficiently high that pinning is inherently provided by the high coercivity. In other cases, a high-coercivity pinning layer can be disposed in proximity to the pinned layer in order to pin it. Such use of a pinning layer to fix the magnetization direction in a pinned layer is well known in the art in connection with various conventional MR sensors, and the same pinning principles are applicable in connection with the present invention.

The free layer should have a sufficiently low coercivity that it can respond to the external magnetic field to be sensed. In addition, it may be necessary to magnetically decouple the free layer from other nearby layers. For example, if barrier 106 on FIG. 1a is pinned, magnetic coupling between barrier 106 and electrode 102 undesirably tends to fix magnetization direction 104 with respect to magnetization direction 108, thereby degrading MR sensor performance.

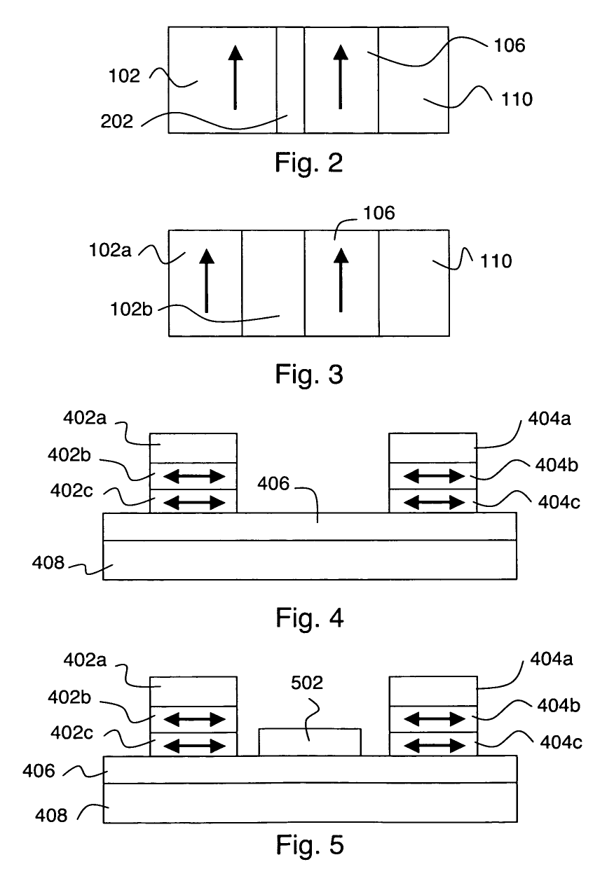

FIG. 2 shows an embodiment of the invention where a decoupling layer is introduced in order to reduce undesirable magnetic coupling between free and pinned layers. More specifically, a decoupling layer 202 is sandwiched between first electrode 102 and tunneling barrier 106 to reduce magnetic coupling between these two layers. Decoupling layer 202 is a thin layer of a non-magnetic material. The use of such magnetic decoupling layers is well known in the art in connection with various conventional MR sensors, and the same decoupling principles are applicable to the present invention. Typical decoupling layer thicknesses are less than about 3 nm. A decoupling layer of MgAl₂O₄ has been employed in experiments relating to the invention, but other non-magnetic materials are also suitable for use as decoupling layers with the invention. The decoupling layer can be insulating (e.g., MgAl₂O₄, CoCr₂O₄, MgO, Al₂0₃, etc.), semiconducting (e.g., Si, Ge, SiGe, GaAs, etc.), or metallic (Ru, V, Pt, Pd, Au, Cu etc.).

As indicated above, provision of spin polarized electrons from the first electrode is a key aspect of the invention. Some ferromagnetic electrical conductors (e.g., half metals and other materials described above) inherently provide spin-polarized electrons. Spin polarized electrons can also be provided by a first electrode including two or more layers, at least one layer being a ferromagnetic electrical conductor. For example, FIG. 3 shows one such embodiment of the invention. In this example, the first electrode includes a ferromagnetic electrically conductive layer 102a and a non-magnetic electrically insulating layer 102b. Such ferromagnet-insulator bilayers can provide a high degree of spin polarization. For example, a spin polarization of 85% has been inferred for a CoFe-MgO ferromagnet-insulator bilayer, based on superconductor spin analyzer measurements from a CoFe/MgO/superconductor junction (Parkin et al., Nature Materials, 3 862 (2004)).

The CoFe layer of the above example can be replaced by any spin-polarized material such as a ferromagnetic alloy including Co, Fe, and/or Ni. The MgO layer can be replaced by any material whose presence enhances the spin polarization of the first electrode.

The invention is applicable to a wide variety of spintronic devices and application, in addition to the magnetoresistive sensing application considered above. Tunnel junctions according to embodiments of the invention can be included in any kind of spintronic device, including but not limited to spin valves, magnetic tunnel junctions, spin switches, spin valve transistors, and spin filters.

FIG. 4 shows a two terminal semiconductor device according to an embodiment of the invention. In this device, a first terminal 402a makes contact to a semiconductor channel 406 on a substrate 408 via a first tunnel junction. The first tunnel junction includes a first electrode 402b and a tunneling barrier 402c. Similarly, a second terminal 404a makes contact to the semiconductor channel 406 via a second tunnel junction. The second tunnel junction includes a first electrode 404b and a tunneling barrier 404c. The first and second tunnel junctions both operate as described above (i.e., the first electrodes 402b and 404b provide spin-polarized electrons, and the ferromagnetic tunneling barriers 402c and 404c provide spin-dependent tunneling barriers.). For both tunnel junctions, semiconductor channel 406 acts as the second electrode (e.g., electrode 110 on FIG. 1a). Thus current provided to semiconductor channel. 406 and/or current received from channel 406 can be spin-filtered.

FIG. 5 shows a three terminal semiconductor device according to an embodiment of the invention. This embodiment is similar to the embodiment of FIG. 4, except that a gate terminal 502 is added. An electrical signal applied to gate terminal 502 can modulate current flow through channel 406 (e.g., as in a field effect transistor), thereby modulating spin transport in the channel.

In a preferred embodiment semiconductor channel 406 can be magnetic to provide additional gains in device performance. It can also be made of multiferroic materials which display ferromagnetism and ferroelectricity simultaneously and have a magnetization responsive to an applied electrical voltage. Similarly, the first electrode and/or second electrode of a tunnel junction according to the invention can include a multiferroic material having a magnetization responsive to an applied electrical voltage.

Modeling and experiments have been done to investigate the performance of various embodiments of the invention. In one experiment, a Fe₃O₄ first electrode 102 was separated from a CoFe₂O₄ tunneling barrier 106 by a MgAl₂O₄ decoupling layer 202, as shown on FIG. 2. The tunnel junction of this experiment was grown on an (001) oriented MgAl₂O₄ substrate by pulsed laser deposition (PLD). A focused KrF excimer laser (248 nm) with a 10 Hz repetition rate and a target fluence of ˜3 J/cm² was employed. A CoCr₂O₄ buffer layer was first grown on the substrate (typical growth conditions were 650° C., 10 mTorr 0₂ atmosphere, 2 nm/min deposition rate). The Fe₃O₄, MgAl₂O₄ and CoFe₂O₄ layers were grown on top of the CoCr₂O₄ buffer layer in sequence, typically at a growth rate of 0.6 nm/min. The Fe₃O₄ layer was deposited at 350° C. in a 10⁻⁶ Torr 0₂ atmosphere, while the MgAl₂O₄ and CoFe₂O₄ layers were deposited at 350° C. in a 10⁻⁵ Torr 0₂ atmosphere. Second electrode 110 was formed by e-beam evaporation of 25 μm×25 μm Au contact pads through a shadow mask.

High quality and near-perfect stoichiometry of the Fe₃O₄ layers grown as above was verified by observation of the Verwey transition for film thicknesses as low as 20 nm. The MgAl₂O₄ and CoFe₂O₄ layers were grown under conditions that did not oxidize the Fe₃O₄ surface. This was confirmed by X-ray photoelectron spectroscopy (XPS) and by observation of the Verwey transition. XPS was also employed to determine the composition of the CoFe₂O₄ layer. A Fe to Co ratio very close to 2 was measured, indicating near-perfect stoichiometry. The spectra also indicate the Co ions are in the +2 formal oxidation state and nearly all of the Fe ions are in the +3 formal oxidation state.

In this structure, the MgAl₂O₄ and CoFe₂O₄ layers both act as tunneling barriers, with barrier heights of 0.8 eV and 0.29 eV respectively. These barrier heights were determined from independent experiments on Fe₃O₄/MgAl₂O₄ and Fe₃O₄/CoFe₂O₄ samples. Tunneling measurements performed on a MgAl₂O₄/CoFe₂O₄ double barrier structure provided results consistent with the barrier heights obtained from single barrier structures.

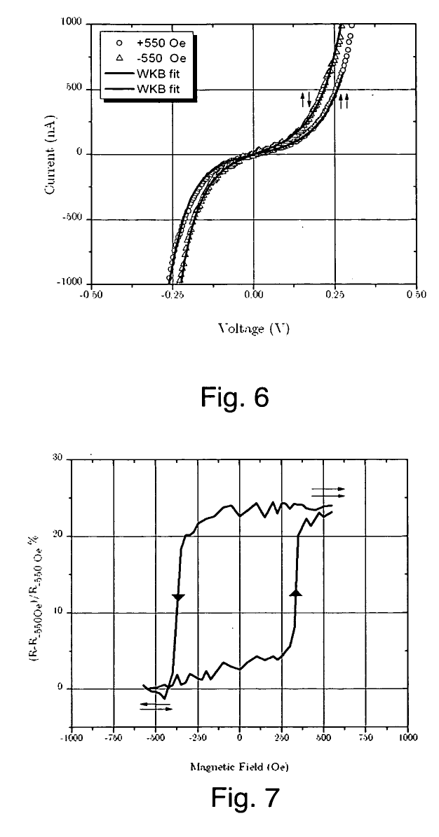

FIG. 6 shows measured I-V curves from a Fe₃O₄(30 nm)/MgAl₂O₄(1 nm)/CoFe₂O₄(3 nm)/Au tunnel junction for parallel (↑↑) and anti-parallel (↑↓) magnetization directions. Since the coercivity of CoFe₂O₄ is higher than that of Fe₃O₄, the CoFe₂O₄ and Fe₃O₄ layers in this tunnel junction act as the pinned and free layers respectively. The sample was initially magnetized in a 12 kOe magnetic field to set the magnetization direction in the pinned layer. Subsequent application of a small external magnetic field of 550 Oe or less was employed to characterize magnetoresistance in this structure. The magnetization direction of the CoFe₂O₄ layer is unaffected by fields of 550 Oe or less, while the Fe₃O₄ layer is free to follow the direction imposed by the small external field. A different resistance is clearly seen on FIG. 6 for parallel and anti-parallel magnetization directions. An MR ratio of about 70% near zero bias is obtained in this case. Lower resistance is observed for anti-parallel magnetization, which is consistent with the CoFe₂O₄ layer as having a partial inverse structure with ˜7-20% of the Co ions in tetrahedral A sites. Based on this analysis, an exchange splitting on the order of 0.1 eV is inferred, which is also consistent with experimental tunnel junction observations.

FIG. 7 shows a typical plot of the magnetoresistance ratio (R-R_{-550Oe})/R_{-550Oe} versus applied magnetic field. Hysteresis is apparent, with a sharp change corresponding to the switching field of the free Fe₃O₄ layer. In this experiment, estimated spin polarizations from the first electrode were in a range from about 10% to about 36%, based on results from several samples. The net spin polarization of electrons emitted from the tunnel junction was calculated to have exceeded 70% for most samples. MR ratios as large as 75% have been experimentally observed.

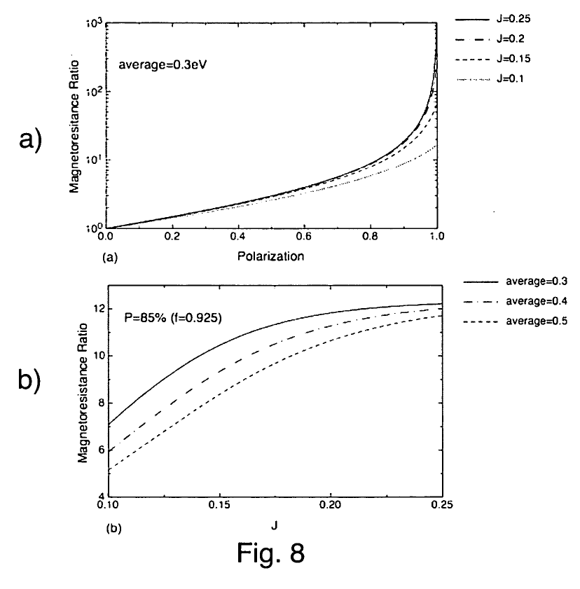

Increasing the exchange splitting provided by barrier 106 and/or the spin polarization provided by first electrode 102 can improve device performance. FIG. 8a shows how the MR ratio for a 3 nm thick insulating barrier having an average barrier height of 0.3 eV varies as a function of spin polarization provided by first electrode 102 for several different values of exchange splitting J. Extremely high MR ratios can be obtained as the spin polarization approaches 100%, which may be difficult to achieve in practice. FIG. 8b shows how the MR ratio for a 3 nm thick insulating barrier varies as a function of exchange splitting J for several values of average barrier height, assuming an incident spin polarization from the first electrode of 85%. Very high MR ratios greater than 10 (i.e., >1,000%) can be obtained in some cases, even though the assumed incident spin polarization is only 85%.

1. A tunnel junction comprising:
a first electrode comprising a ferromagnetic, electrically conductive first layer having a first magnetization direction, wherein electrons emitted from the first electrode are substantially spin-polarized according to the first magnetization direction;
an electrically conductive second electrode;
a ferromagnetic, electrically insulating tunneling barrier having a second magnetization direction, wherein the tunneling barrier is disposed between the first and second electrodes such that electrons can tunnel through the tunneling barrier between the first and second electrodes;
wherein an electrical resistance of the tunnel junction between the first and second electrodes depends on a relative orientation of the second magnetization direction with respect to the first magnetization direction.

2. The tunnel junction of claim 1, wherein said emitted electrons are substantially spin-polarized parallel to said first magnetization direction.

3. The tunnel junction of claim 1, wherein said emitted electrons are substantially spin-polarized anti-parallel to said first magnetization direction.

4. The tunnel junction of claim 1, further comprising a non-magnetic decoupling layer disposed between said first electrode and said tunneling barrier, whereby magnetic coupling between said first electrode and said tunneling barrier is reduced.

5. The tunnel junction of claim 4, wherein said decoupling layer comprises MgAl₂O₄.

6. The tunnel junction of claim 4, wherein a thickness of said decoupling layer is less than 3 nm.

7. The tunnel junction of claim 1, wherein said first magnetization direction is pinned and wherein said second magnetization direction is free to respond to an external magnetic field.

8. The tunnel junction of claim 7, further comprising a pinning layer in proximity to said first electrode, wherein said first magnetization direction is pinned by the pinning layer.

9. The tunnel junction of claim 7, wherein a coercivity of said first electrode is sufficiently high to pin said first magnetization direction.

10. The tunnel junction of claim 1, wherein said second magnetization direction is pinned and wherein said first magnetization direction is free to respond to an external magnetic field.

11. The tunnel junction of claim 10, further comprising a pinning layer in proximity to said tunneling barrier, wherein said second magnetization direction is pinned by the pinning layer.

12. The tunnel junction of claim 10, wherein a coercivity of said tunneling barrier is sufficiently high to pin said second magnetization direction.

13. The tunnel junction of claim 1, wherein said first electrode comprises a half-metallic ferromagnet.

14. The tunnel junction of claim 1, wherein said first electrode comprises a material selected from the group consisting of Fe₃O₄, La_{2/3}Sr_{1/3}MnO₃, CrO₂, and Co doped ZnO.

15. The tunnel junction of claim 1, wherein said first electrode comprises a conductive ferromagnet/insulator bilayer providing substantial spin polarization of emitted electrons.

16. The tunnel junction of claim 15, wherein said conductive ferromagnet/insulator bilayer comprises a CoFe/MgO bilayer.

17. The tunnel junction of claim 1, wherein said tunneling barrier comprises a material selected from the group consisting of CoFe₂O₄, NiFe₂O₄, MnFe₂O₄, and other ferrites.

18. The tunnel junction of claim 1, wherein said second electrode is non-magnetic.

19. The tunnel junction of claim 1, wherein said second electrode is magnetic or spin-polarized.

20. A spintronic device including the tunnel junction of claim 1.

21. The spintronic device of claim 20, wherein a magnetization of at least one of said first electrode and said second electrode is responsive to an applied voltage.

22. The spintronic device of claim 20, wherein the spintronic device is selected from the group consisting of spin valves, magnetic tunnel junctions, spin switches, spin valve transistors, and spin filters.

23. A two terminal spintronic device comprising:
a first terminal;
a semiconductor channel;
a second terminal;
a first tunnel junction according to claim 1, acting as a first spin filter and connecting the first terminal to the semiconductor channel;
a second tunnel junction according to claim 1, acting as a second spin filter and connecting the second terminal to the semiconductor channel;
whereby electrons provided to or received from the semiconductor channel can be spin-filtered.

24. The spintronic device of claim 23, wherein said semiconductor channel is magnetic.

25. The spintronic device of claim 23, wherein said semiconductor channel is multiferroic.

26. A three terminal spintronic device comprising:
a first terminal;
a semiconductor channel;
a second terminal;
a first tunnel junction according to claim 1, acting as a first spin filter and connecting the first terminal to the semiconductor channel;
a second tunnel junction according to claim 1, acting as a second spin filter and connecting the second terminal to the semiconductor channel;
a gate terminal disposed such that an electrical gate signal applied to the gate terminal can alter an electrical conductivity of the semiconductor channel;
whereby electrons provided to or received from the semiconductor channel can be spin-filtered;
whereby spin transport in the semiconductor channel can be altered by said electrical gate signal.

27. The spintronic device of claim 26, wherein said semiconductor channel is magnetic.

28. The spintronic device of claim 26, wherein said semiconductor channel is multiferroic.

29. A method of altering an electrical resistance, the method comprising:
providing a first electrode comprising a ferromagnetic, electrically conductive layer having a first magnetization direction, wherein electrons emitted from the first electrode are substantially spin-polarized according to the first magnetization direction;
providing an electrically conductive second electrode;
providing a ferromagnetic, electrically insulating tunneling barrier having a second magnetization direction, wherein the tunneling barrier is disposed between the first and second electrodes such that electrons can tunnel through the tunneling barrier between the first and second electrodes; and
altering an electrical resistance between the first and second electrodes by altering a relative orientation of the second magnetization direction with respect to the first magnetization direction.
